(19) United States
(12) Patent Application Publication
(10) Pub. No.: US 2021/0291796 A1
(43) Pub. Date: Sep. 23, 2021

(54) CONTROL OF A BRAKING PROCESS

(71) Applicant: Ford Global Technologies, LLC, Dearborn, MI (US)

(72) Inventors: Andreas Ediger, Cologne (DE); Franziskus Bauer, Huerth (DE); Lukas Oliver Schrumpf, Solingen (DE); Katharina Ziegler, Pulheim (DE); Harald Koerfgen, Hürth (DE)

(73) Assignee: Ford Global Technologies, LLC, Dearborn, MI (US)

(21) Appl. No.: 17/184,934

(22) Filed: Feb. 25, 2021

(30) Foreign Application Priority Data
Mar. 23, 2020 (DE) 102020107883.8

(51) Int. Cl. B60T 8/172; B60T 8/171

(52) U.S. Cl. CPC B60T 8/172; B60T 8/171; B60T 2201/16; B60T 2210/32; B60T 2210/20; B60T 2201/02

(57) ABSTRACT

A method for controlling a braking process of a motor vehicle having an intelligent cruise control and a navigation unit is provided, wherein the braking process is divided into multiple phases in which different deceleration rates are present. Furthermore, a motor vehicle for executing the method is provided.

### CROSS-REFERENCE TO RELATED APPLICATIONS

This patent application claims priority to German Application No. 102020107883.8, filed Mar. 23, 2020, which is hereby incorporated herein by its reference in its entirety.

### BACKGROUND

Adaptive cruise controls (ACC), which automatically regulate the rotational speed of an engine in such a way that a vehicle maintains a speed predetermined by the driver if possible, are known. Many vehicles often have a driver assistance system for assisting the driver in maintaining the current speed limit on the presently traveled road section, namely a so-called intelligence speed assistant or intelligent adaptive cruise control (IACC). The IACC reacts in this case to other vehicles, obstacles, and traffic signs in order to adapt the speed of the affected motor vehicle.

### SUMMARY

The present disclosure relates to controlling a braking process of a motor vehicle having an intelligent cruise control (IACC) and a motor vehicle for executing such control. The IACC is designed to execute braking processes automatically if a situation requiring a speed reduction occurs. Such situations are, e.g., an approach to diverse curves, to obstacles, or to other vehicles on the roadway. In the case of automatic braking, an IACC uses a braking profile. This braking profile is typically selected on the basis of certain criteria, for example with regard to the fuel economy and/or conveying an acceptable braking feeling for the driver and further occupants. Similar braking processes may feel different from braking executed by a human driver and may convey a less natural braking feeling. For example, braking processes which appear to begin relatively late could result in nervousness in the occupants.

In one example, a method for controlling a braking process of a driving motor vehicle having an intelligent cruise control and a navigation unit comprises:
detecting an upcoming situation requiring a speed reduction,
calculating a final speed,
programming a braking process,
executing the programmed braking process,
wherein the braking process includes at least one phase having a first deceleration value of the speed and at least one phase having a second deceleration value of the speed.

The method is advantageous because phases having different deceleration values convey a braking feeling which better correspond to the braking of a human driver.

In the method, the braking process is preferably divided into three phases having different deceleration values. This has the advantage that the braking process can be controlled efficiently.

Preferably, in a first phase of the braking process, a deceleration of the speed which is lighter in relation to a constant braking process is exerted. In other words, the deceleration value in the first phase is less than in the case of a constant braking process. A correspondingly light deceleration initiates the braking process, so that the driver of the motor vehicle is made aware that a braking process is initiated in a timely manner. Trust in the automatic system is thus also built up. Moreover, it is also made clear to the driver that a situation which they have not yet perceived is upcoming which makes a speed reduction necessary.

Preferably, in a second phase of the braking process, a stronger deceleration in relation to a constant braking process is exerted. In other words, the deceleration value in the second phase is stronger than in the case of a constant braking process. In this phase, the speed is actively decelerated. After light braking in the first phase, this stronger deceleration corresponds to the behavior of a human driver. Moreover, the driver should now also be able to recognize the situation requiring a speed reduction.

Preferably, in a third phase, a lighter deceleration in relation to the second phase is exerted. In other words, the deceleration value in the third phase is less than in the second phase. This third phase is advantageous because the ability to control the braking process is enhanced. Moreover, an acceleration beginning after the braking process, for example in a curve, is facilitated since during the acceleration on the vertex of the curve, the transition from braking to acceleration is not so abrupt. Furthermore, the slower braking enables more time for the driver to survey a traffic situation which made the speed reduction necessary, for example in an intersection region.

The situation requiring a speed reduction can be ascertained based on data of the navigation unit. Route details such as intersections and curves of the calculated route are stored in the navigation unit. This embodiment of the method is therefore particularly suitable for decelerating before curves, intersections, and roundabouts.

In the method, the situation requiring a speed reduction also can be recognized by means of sensors of the motor vehicle. This is advantageous for recognizing obstacles not predictable on the basis of map information, for example stationary or slowly driving vehicles. The recognition sensors can be carried out both alternatively and also in combination with the recognition based on data of the navigation unit.

A curve can be ascertained as the situation requiring a speed reduction. The curve can be a slight curve, a bend, a hairpin bend into a winding road, or also a roundabout, without being restricted to this list. The curve is ascertained on the basis of items of map information which are stored in a storage unit of the navigation system or are available online (cloud). The curve can also be ascertained on the basis of GPS data, onboard environmental sensors, and/or by means of an optical imaging unit, for example a camera. Items of information which are obtained on the basis of a vehicle-to-vehicle communication or vehicle-to-infrastructure communication are also usable for detecting the curve.

A motor vehicle can include at least one navigation unit and one control unit, which is designed to control deceleration according to the method described herein.

### BRIEF SUMMARY OF THE DRAWINGS

The present disclosure is explained in greater detail on the basis of the figures. In the figures:

FIG. 1 shows a schematic illustration of an embodiment of an example motor vehicle.

FIG. 2 shows a flow chart of an example method.

FIG. 3 shows a graphic representation of a curve of a roadway.

FIG. 4 shows a diagram to compare different braking process profiles.

### DESCRIPTION

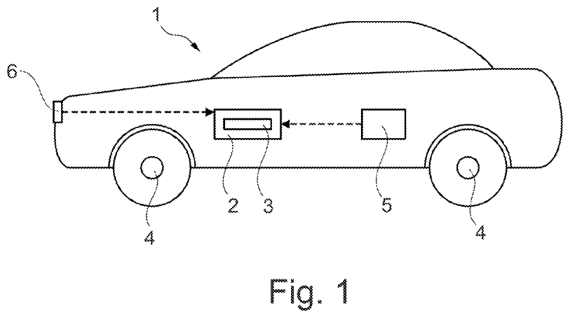

An embodiment of an example motor vehicle 1 is shown in FIG. 1. The motor vehicle 1 includes a control unit 2. An intelligent adaptive cruise control (IACC) 3 is implemented in the control unit 2. The control unit 2 is designed to control the brakes 4 of the motor vehicle 1, to thus actuate them as needed at various strengths. Furthermore, an engine controller is implemented in the control unit 2, using which, for example the rotational speed of an engine of the motor vehicle 1 is controlled, in order to control the speed of the motor vehicle 1 via this. The control unit 2 is connected to a navigation unit 5.

The motor vehicle 1 furthermore includes a camera 6 as an optical imaging unit. The camera 6 is capable of detecting obstacles which make a braking process necessary. Alternatively or additionally, the motor vehicle 1 can include further sensors, for example environmental sensors based on ultrasound, RADAR, or LIDAR. Furthermore, the motor vehicle 1 can be designed for vehicle-to-vehicle communication and/or vehicle-to-infrastructure communication.

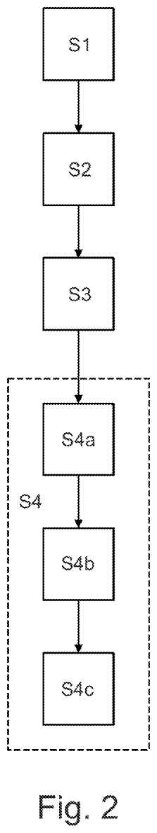

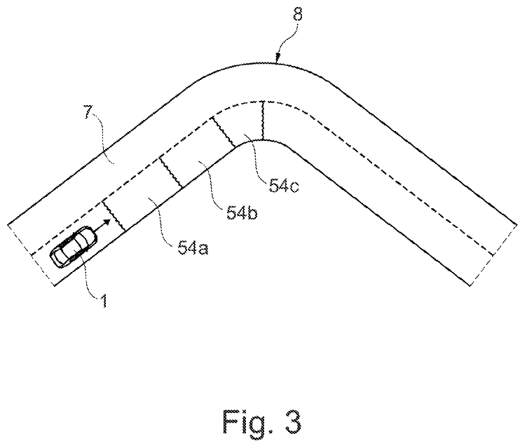

In one example as illustrated in FIG. 2, a braking process is carried out in three phases. A motor vehicle 1 moves on a roadway 7 (FIG. 3). The arrow indicates the travel direction of the motor vehicle 1. According to the flow chart of FIG. 2, in a first step S1, an upcoming situation requiring a speed reduction is detected. For this purpose, the control unit 2 evaluates items of map information and position data of the navigation unit, which indicate an imminent curve 8 of the roadway 7. Alternatively or in combination with the navigation unit 5, for example, data of the camera 6 and/or a vehicle-to-vehicle communication can also be used.

The curve 8 is too steep to be able to be passed without braking (FIG. 3). The control unit 2 calculates a final speed vₑ in a second step S2. The final speed vₑ is the speed at which the motor vehicle 1 is supposed to move at the end of the braking process. The final speed vₑ is situation-dependent. To drive through the curve, a speed vₑ is advantageous which enables driving through the curve and rapid acceleration on the vertex of the curve. The final speed vₑ can also be zero if a full stop is required before an obstacle. In a third step S3, a corresponding braking process is programmed, which is to have three phases.

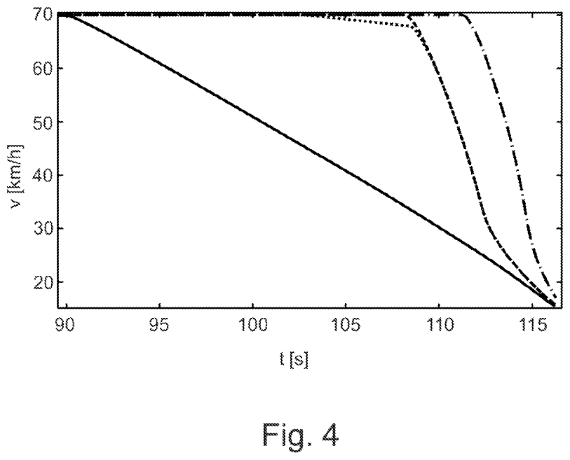

In a fourth step S4, the programmed braking process is executed (see FIG. 4, dotted line). In a first phase S4a, the motor vehicle 1 is only lightly braked. Light is to be understood here in relation to a constant braking process having uniform deceleration (see FIG. 4, graph having solid line), thus that the deceleration is less. During this first phase S4a, the occupant of the motor vehicle 1 is made aware that a braking process is initiated.

In a second phase S4b, the motor vehicle 1 is strongly decelerated. Strong is to be understood here in relation to a constant braking process having uniform deceleration (FIG. 4), thus that the deceleration is stronger. The deceleration is similarly strong here as in two-phase braking processes also shown in FIG. 4, which have a deceleration of −2.5 ms⁻² (graph having dot-dash line) or −2 ms⁻² (dashed line graph).

In a third phase S4c, the motor vehicle 1 is braked more lightly, wherein the deceleration is still stronger than in the case of a constant braking process (FIG. 4). The deceleration corresponds here to the second phase of the two-phase braking process at −2 ms⁻² (FIG. 4, dashed line graph). At the end of the third phase S4c, the motor vehicle 1 has reached the final speed vₑ. After the braking process before the curve 8, the motor vehicle 1 can accelerate again at the vertex of the curve 8 (FIG. 3).

### LIST OF REFERENCE NUMERALS

1 Motor vehicle
2 Control unit
3 Intelligent cruise control
4 Brakes
5 Navigation unit
6 Camera
7 Roadway
8 Curve

1-9. (canceled)

10. A method for controlling braking of a motor vehicle having an intelligent cruise control and a navigation unit, the method comprising:
detecting an upcoming situation requiring a speed reduction;
calculating a final speed;
programming a braking process; and
executing the programmed braking process;
wherein the programmed braking process includes at least one phase having a first deceleration value of the speed and at least one phase having a second deceleration value of the speed.

11. The method of claim 10, wherein the braking process is divided into three phases, each having different deceleration values.

12. The method of claim 10, wherein, in a first phase, a lesser deceleration of the speed is exerted in relation to a constant braking process.

13. The method of claim 10, wherein, in a second phase, a stronger deceleration is exerted in relation to a constant braking process.

14. The method of claim 10, wherein, in a third phase, a lesser deceleration is exerted in relation to the second phase.

15. The method of claim 10, wherein the situation requiring a speed reduction is ascertained based on data of the navigation unit.

16. The method of claim 10, wherein the situation requiring a speed reduction is recognized by data from sensors of the motor vehicle.

17. The method of claim 10, wherein a curve is ascertained as the situation requiring a speed reduction.

18. A system for a motor vehicle, comprising:
a navigation unit; and
a control unit communicatively connected to the navigation unit and configured to:
detect an upcoming situation requiring a speed reduction;
calculate a final speed;
program a braking process; and
execute the programmed braking process;
wherein the programmed braking process includes at least one phase having a first deceleration value of the speed and at least one phase having a second deceleration value of the speed

19. The system of claim 18, wherein the braking process is divided into three phases, each having different deceleration values.

20. The system of claim 18, wherein, in a first phase, a lesser deceleration of the speed is exerted in relation to a constant braking process.

21. The system of claim 18, wherein, in a second phase, a stronger deceleration is exerted in relation to a constant braking process.

22. The system of claim 18, wherein, in a third phase, a lesser deceleration is exerted in relation to the second phase.

23. The system of claim 18, wherein the situation requiring a speed reduction is ascertained based on data of the navigation unit.

24. The system of claim 18, wherein the situation requiring a speed reduction is recognized by data from sensors of the motor vehicle.

25. The system of claim 18, wherein a curve is ascertained as the situation requiring a speed reduction.
